(19) United States
(12) Patent Application Publication
(10) Pub. No.: US 2009/0136204 A1
(43) Pub. Date: May 28, 2009

(54) SYSTEM AND METHOD FOR REMOTE LIVE PAUSE

(76) Inventors: Yueh-Hua Chen, Kaohsiung City (TW); Chia-San Lee, Hsinchu City (TW); Chen Ma, San Jose, CA (US); Ching-Lung Chen, Hsinchu City (TW); Yung-Hsiao Lai, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/273,553

(22) Filed: Nov. 19, 2008

(30) Foreign Application Priority Data
Nov. 26, 2007 (TW) 096144817

(51) Int. Cl. H04N 5/91

(52) U.S. Cl. 386/68; 386/E05.001

(57) ABSTRACT

A remote live pause method establishes a connection between a client and a server, and transmits a time-shift start command to the server through the connection, a bit-stream of a live media data to the client through the connection according to the time-shift start command, and a time-shift command to the server through the connection to start a trick play function at the client.

### BACKGROUND OF THE INVENTION

1. Field of the Invention

The present invention relates to a method and system for playing media data, and more particularly, to a remote live pause method and system for performing trick play functions through a remote connection.

2. Description of the Prior Art

Digital video have been popularly utilized in daily applications. These applications include the development of digital video recorders (DVR), which are made to suit specific demands. The users of a DVR may rewind and review the videos belonging to previous time intervals and may retrieve outstanding pictures missed during an earlier time.

Nonetheless, conventional DVR can only record and play live video contents or perform trick play functions within the same device. Regarding users at a remote side, such applications are significantly limited due to its inconvenience.

### SUMMARY OF THE INVENTION

It is one of the objectives of the claimed invention to provide a remote live pause method and related system for performing trick play functions through a connection to solve the abovementioned problems.

According to an exemplary embodiment of the present invention, a remote live pause method is provided. The remote live pause method includes establishing a connection between a client and a server, transmitting a time-shift start command to the server through the connection, transmitting bit-stream of a live media data to the client through the connection according to the time-shift start command, and transmitting a time-shift command to the server through the connection to start a playback function at the client. The playback function includes at least one of play, pause, instant replay, rewind, fast forward, previous chapter, next chapter, zoom, and commercial skip functions.

According to an exemplary embodiment of the present invention, a remote live pause system is provided. The remote live pause system includes a transmission network, a server, and a client. The server is coupled to the transmission network for storing bit-stream of a live media data. The client is coupled to the transmission network for transmitting a time-shift start command to the server through the transmission network to receive the bit-stream of the live media data from the server, and for transmitting a time-shift command to the server through the transmission network to start a playback function at the client.

In one embodiment, the server may be implemented with a digital video recorder. The client on the other hand, may also be implemented with a digital video recorder or may even include a computer equipped with a designated software, wherein the computer executes the designated software to implement functions at the client.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a remote live pause system according to an embodiment of the present invention.

FIG. 2 is a diagram showing the interactive manner between the server and the client in FIG. 1.

FIG. 3 is a flowchart illustrating a remote live pause method according to an exemplary embodiment of the present invention.

FIG. 4 is a diagram of an example of the index information shown in FIG. 1.

FIG. 5 is a diagram of a video object unit.

### DETAILED DESCRIPTION

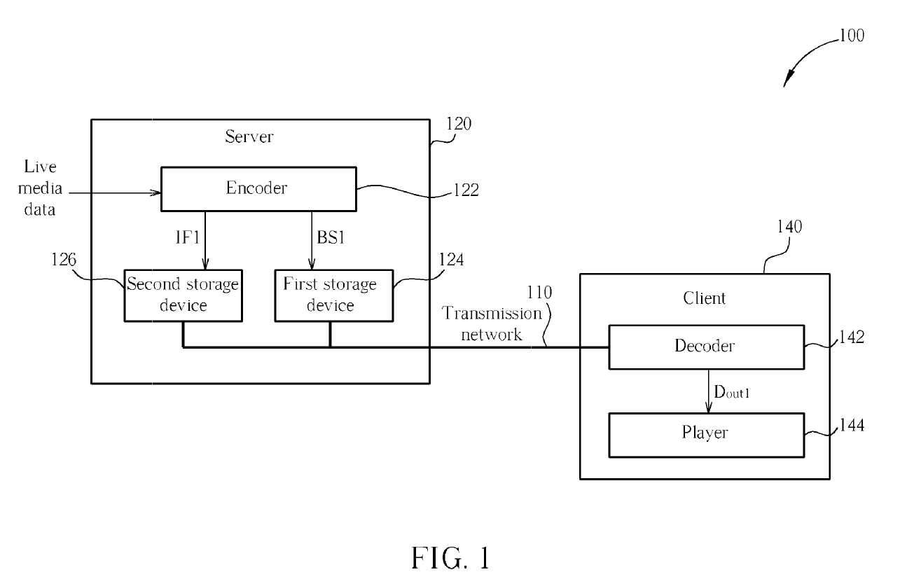

Please refer to FIG. 1. FIG. 1 is a diagram of a remote live pause system 100 illustrated according to an embodiment of the present invention. The remote live pause system 100 includes, but is not limited to, a transmission network 110, a server 120, and a client 140. The server is coupled to the transmission network 110 and includes an encoder 122, a first storage device 124, and a second storage device 126. The encoder 122 receives and encodes a live media data to generate a bit-stream of the live media data BS1. The first storage device 124 is coupled to the encoder 122 for storing the bit-stream of the live media data BS1, and the second storage device 126 is coupled to the encoder 122 for storing index information IF1. The client 140 is coupled to the transmission network 110 and includes a decoder 142 and a player 144. The decoder 142 receives and decodes the bit-stream of the live media data BS1 to generate a decoding output Dout1. The player 144 is coupled to the decoder 142 for playing the decoding output Dout1 generated by the decoder 142 to perform a trick play function. In this embodiment, the client 140 transmits a time-shift start command to the server 120 through the transmission network 110 to receive the bit-stream of the live media data BS1 from the server 120, and then transmits a time-shift command to the server 120 through the transmission network 110 to start the trick play function at the client 140.

In the embodiment above, the trick play function can include functions such as play, pause, instant replay, rewind, fast forward, previous chapter, next chapter, zoom, and commercial skip, but is not limited to this only. Moreover, the index information IF1 can be used for storing information such as locations where the first storage device 124 stores the bit-stream of the live media data BS1 and corresponding timing information. The trick play function can be performed according to the bit-stream of the live media data BS1 and the index information IF1.

Please note that, the abovementioned first storage device 124 can be a hard disk and the second storage device 126 can be a memory, or they can be storage devices of other types. The first storage device 124 and the second storage device 126 can alternatively be different storage blocks of the same storage device without departing from the spirit of the present invention.

Note further that the abovementioned live media data can include data such as audiovisual bit streams transmitted from Internet or TV broadcasting signals transmitted from content/service providers, etc., but is not limited to this. In other words, the remote live pause system 100 of the present invention does not restrict the source of the live media data. Furthermore, the server 120 can be a digital video recorder (DVR) and/or the main elements included in a DVR. This should not be made a limitation of the present invention since other devices with digital recording/playing functions or those comprising the main elements of the abovementioned DVR can also be used for implementing the server 120. In addition, the client 140 can be a DVR, or can be an apparatus including a computer equipped with a designated software, where the computer executes the designated software to implement functions at the client 140. Those skilled in the art should know that this should not be a limitation of the present invention, that is, the client 140 can also be devices of other types.

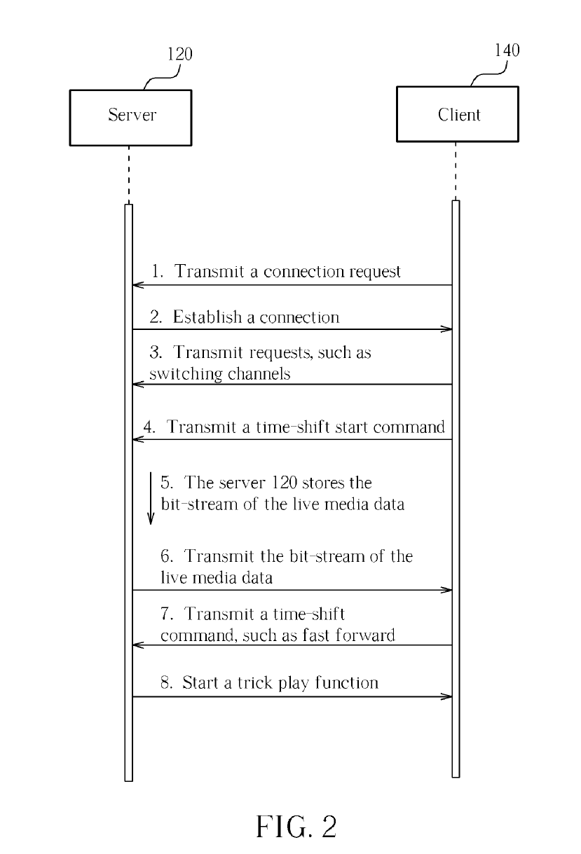

Please refer to FIG. 2. FIG. 2 is a diagram showing the interactive manner between the server 120 and the client 140 in FIG. 1. In the following descriptions, please also refer to FIG. 1 at the same time. As shown in FIG. 2, the client 140 first transmits a connection request to the server 120 for the request of establishing a connection, and then the server 120 establishes the connection between the client 140 and the server 120 (i.e., the transmission network 110 shown in FIG. 1. Please note that, the transmission network 110 can be wired, wireless or combined, and should all belong to the scope of the present invention). At this time, the client 140 can transmit some requests, such as switching channels, to the server 120 through the transmission network 110. The client 140 transmits a time-shift start command to the server 120 to notify the server 120 of starting time-shift functions, and the server 120 starts to store the bit-stream of the live media data BS1 into the first storage device 124. After a while, the server 120 transmits the bit-stream of the live media data BS1 to the client 140 through the transmission network 110. At this time, the client 140 can transmit a time-shift command, such as play, pause, instant replay, rewind, fast forward, previous chapter, next chapter, zoom, and commercial skip functions, etc., to the server 120 through the transmission network 110. The client 120 may then start the abovementioned trick play function, which is performed at the player 144 of the client 140 according to the data provided by the server 120.

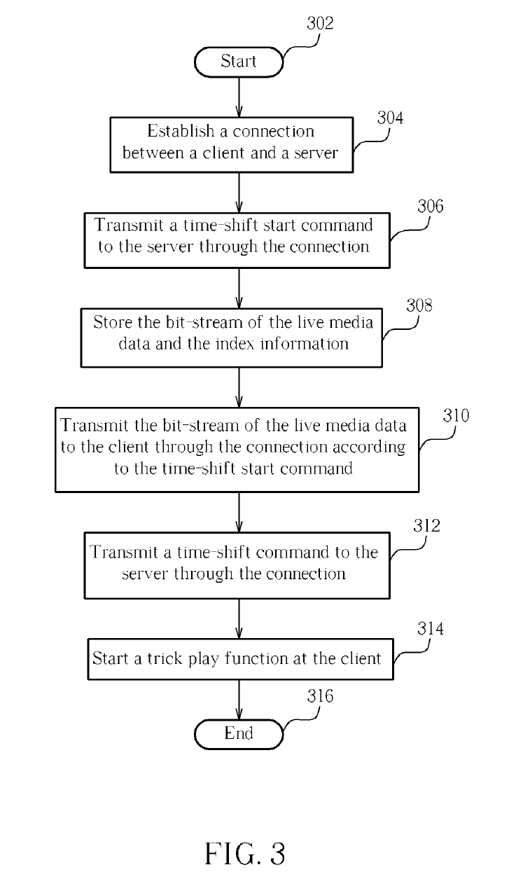

Please refer to FIG. 3. FIG. 3 is a flowchart illustrating a remote live pause method according to an exemplary embodiment of the present invention. Please note that the following steps are not limited to be performed according to the exact sequence shown in FIG. 3 if a roughly identical result can be obtained. The remote live pause method includes, but is not limited to, the following steps:

Step 302: Start.

Step 304: Establish a connection between a client and a server.

Step 306: Transmit a time-shift start command to the server through the connection.

Step 308: Store the bit-stream of the live media data and the index information.

Step 310: Transmit the bit-stream of the live media data to the client through the connection according to the time-shift start command.

Step 312: Transmit a time-shift command to the server through the connection.

Step 314: Start a trick play function at the client.

Step 316: End.

Please note that the operations of the remote live pause system 100 have already been detailed above, and further description of steps in FIG. 3 is omitted here for brevity.

Please also note that the abovementioned steps in the flowchart are merely an embodiment of the present invention, and in no way should be considered to be limitations of the scope of the present invention. The steps of the method shown in FIG. 3 need not be in the exact order shown and need not be contiguous, that is, other steps can be intermediate without departing from the spirit of the present invention.

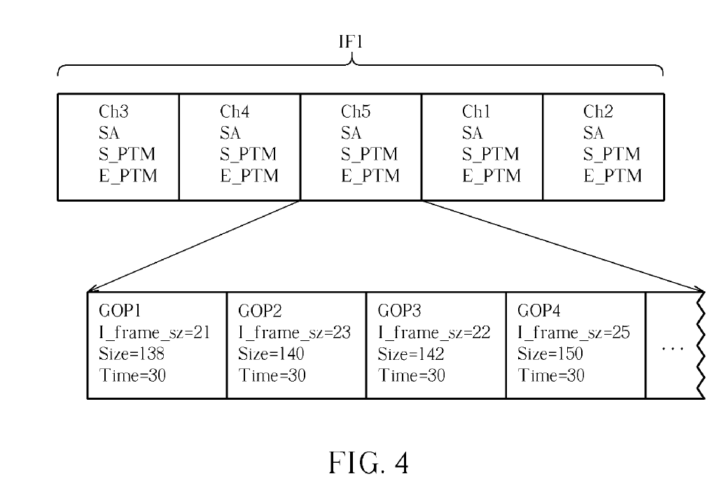

Please refer to FIG. 4. FIG. 4 is a diagram of an example of the index information IF1 shown in FIG. 1. Inside the server 120, the index information IF1 may be stored into the second storage device 126, and the bit-stream of the live media data BS1 is stored into the first storage 124. As shown in FIG. 4, if the bit-stream of the live media data BS1 includes a plurality of chapters Ch1-Ch5, the index information IF1 records a start address SA, a start presentation time S_PTM, and an end presentation time E_PTM of each of the chapters Ch1-Ch5. Each of the chapters Ch1-Ch5 includes a plurality of groups of pictures GOP1-GOP4, and the index information IF1 also records a frame size of I-frame (I_frame_sz) of each group of pictures, a size of each group of pictures, and a time length of each group of pictures. Therefore, the index information IF1 can support trick play functions, such as, play, pause, instant replay, rewind, fast forward, previous chapter, next chapter, zoom, and commercial skip, etc. In other words, when the client 140 transmits the abovementioned time-shift command to the server 120, the server 120 finds out the wanted part of the wanted file according to the current location and the index information IF1 and then transmits it to the client 140 for the follow-up playback. Because the index information IF1 stores the start address of each chapter, it would take very little time for users to jump the wanted part to be played.

These embodiments above are presented merely for describing applications of the present invention, and in no way should be considered to be limitations of the scope of the present invention. It will be obvious to those skilled in the art that various modifications of the index information IF1 may be made without departing from the spirit of the present invention.

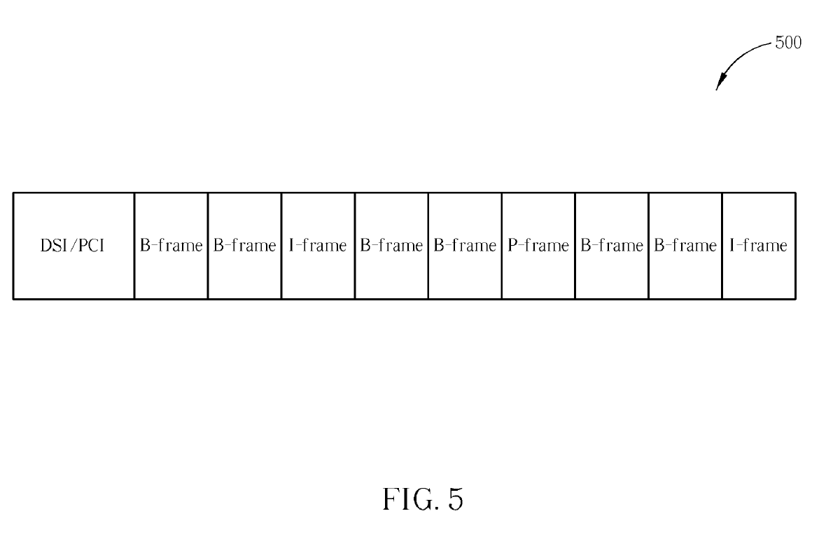

In the following, one example is brought up for illustrating how the trick play function is performed. Please refer to FIG. 5. FIG. 5 is a diagram of a video object unit (VOBU) 500. As shown in FIG. 5, data search information (DSI) and presentation control information (PCI) are located in the start address of the VOBU 500, and the VOBU 500 includes numerous intra frames (I-frame), bidirectional frames (B-frame), and predictive frames (P-frame). If the users desire to perform a fast forward function with high speeds (for example, 8 times, 15 times, or higher), the server 120 abandons the B-frames and the P-frames and only transmits the I-frames to the client 140 through the transmission network 110. In comparison with transmitting the whole group of pictures to the client 140, abandoning a part of frames can save more network bandwidth.

The abovementioned embodiments are presented merely for describing the present invention, and in no way should be considered to be limitations of the scope of the present invention. The abovementioned trick play function can include functions such as play, pause, instant replay, rewind, fast forward, previous chapter, next chapter, zoom, and commercial skip, but is not limited to this only. The index information IF1 can be used for storing information such as locations where the first storage device 124 stores the bit-stream of the live media data BS1 and corresponding timing information, but is not limited to this only. Please note that, the abovementioned first storage device 124 can be a hard disk and the second storage device 126 can be a memory, or they can be storage devices of other types. Furthermore, the server 120 can be a DVR and/or the main elements included in a DVR. But this should not be a limitation of the present invention as well, and the server 120 can be a device of another type. In addition, the client 140 can be a DVR, or can be an apparatus including a computer equipped with a designated software, wherein the computer executes the designated software to implement functions at the client 140. But this is not a limitation of the present invention, and the client 140 can be a device of another type.

In summary, the present invention provides a method and related system for remote live pause. Through the remote live pause method disclosed in the present invention, it can provide more functions when the users are using video tools. For example, the users can watch TV shows that are currently played in other countries through the transmission network and can simultaneously perform some trick play functions, such as fast forward, rewind, instant replay, or commercial skip, through the transmission network. It is extremely convenient for the users at the remote side.

Those skilled in the art will readily observe that numerous modifications and alterations of the device and method may be made while retaining the teachings of the invention.

What is claimed is:

1. A method for remote live pause, comprising:
establishing a connection between a client and a server;
transmitting a time-shift start command to the server through the connection;
transmitting bit-stream of a live media data to the client through the connection according to the time-shift start command; and
transmitting a time-shift command to the server through the connection to start a playback function at the client.

2. The method of claim 1, further comprising:
storing the bit-stream of the live media data and index information.

3. The method of claim 2, wherein the bit-stream of the live media data comprises a plurality of chapters, and the index information stores at least one of a start address, a start presentation time, and an end presentation time of the plurality of chapters.

4. The method of claim 3, wherein the chapters comprise a plurality of groups of pictures, and the index information further stores a frame size of an I-frame of each group of pictures, a size of each group of pictures, and a time length of each group of pictures.

5. The method of claim 1, wherein the playback function comprises at least one of play, pause, instant replay, rewind, fast forward, previous chapter, next chapter, zoom, and commercial skip functions.

6. The method of claim 1, wherein the step of transmitting the bit-stream of the live media data to the client through the connection comprises:
before transmitting the bit-stream of the live media data to the client, abandoning a part of frames of the live media data in advance and transmitting the remnant frames of the live media data to the client through the connection.

7. The method of claim 6, wherein a frame type of the part of abandoned frames comprises at least one of an I-frame, a B-frame and a P-frame.

8. A remote live pause system, comprising:
a transmission network;
a server, coupled to the transmission network, for storing bit-stream of a live media data; and
a client, coupled to the transmission network, for transmitting a time-shift start command to the server through the transmission network to receive the bit-stream of the live media data from the server, and for transmitting a time-shift command to the server through the transmission network to start a playback function at the client.

9. The remote live pause system of claim 8, wherein the server comprises:
an encoder, for receiving and encoding the live media data to generate the bit-stream of the live media data;
a first storage device, coupled to the encoder, for storing the bit-stream of the live media data; and
a second storage device, coupled to the encoder, for storing index information.

10. The remote live pause system of claim 9, wherein the bit-stream of the live media data comprises a plurality of chapters, and the index information stores at least one of a start address, a start presentation time, and an end presentation time of the plurality of chapters.

11. The remote live pause system of claim 10, wherein the chapters comprise a plurality of groups of pictures, and the index information further stores a frame size of an I-frame of each group of pictures, a size of each group of pictures, and a time length of each group of pictures.

12. The remote live pause system of claim 9, wherein the client comprises:
a decoder, for receiving and decoding the bit-stream of the live media data to generate a decoding output; and
a player, coupled to the decoder, for playing the decoding output to perform the playback function.

13. The remote live pause system of claim 8, wherein the playback function comprises at least one of play, pause, instant replay, rewind, fast forward, previous chapter, next chapter, zoom, and commercial skip functions.

14. The remote live pause system of claim 8, wherein the server comprises a digital video recorder.

15. The remote live pause system of claim 8, wherein the client comprises a digital video recorder.

16. The remote live pause system of claim 8, wherein the client comprises a computer equipped with a designated software, and the computer executes the designated software to implement functions at the client.

17. The remote live pause system of claim 8, wherein a part of frames of the live media data is abandoned in advance and the remnant frames of the live media data is transmitted to the client through the transmission network before transmitting the bit-stream of the live media data to the client.

18. The remote live pause system of claim 17, wherein a frame type of the part of abandoned frames comprises at least one of an I-frame, a B-frame and a P-frame.
